(19) United States
(12) Patent Application Publication
(10) Pub. No.: US 2026/0348130 A1
(43) Pub. Date: Nov. 5, 2026

(54) CONTROL DEVICE AND CONTROL METHOD

(71) Applicants: KOBELCO CONSTRUCTION MACHINERY CO., LTD., Hiroshima-shi (JP); HIROSHIMA UNIVERSITY, Higashi-Hiroshima-shi (JP)

(72) Inventors: Ryo KIKUUWE, Hiroshima (JP); Yuki YAMAMOTO, Hiroshima (JP)

(73) Assignees: KOBELCO CONSTRUCTION MACHINERY CO., LTD., Hiroshima-shi (JP); HIROSHIMA UNIVERSITY, Higashi-Hiroshima-shi (JP)

(21) Appl. No.: 19/103,103

(22) PCT Filed: Aug. 24, 2023
(86) PCT No.: PCT/JP2023/030465

§ 371 Date: Feb. 11, 2025

(30) Foreign Application Priority Data
Aug. 26, 2022 (JP) 2022-134748
Aug. 4, 2023 (JP) 2023-127490

(51) Int. Cl. E02F 9/22; E02F 3/43; F15B 11/024

(52) U.S. Cl. CPC E02F 9/2203; E02F 9/2217; E02F 9/2278; F15B 11/024; E02F 3/435

(57) ABSTRACT

A control device includes: a movement instruction part that controls each cylinder for driving an excavator that is a control object; a desirable velocity calculation part that calculates a desirable velocity to be produced in a next timestep based on a target position and a current position of a bucket leading end; a reference velocity calculation part that calculates, based on a quasistatic characteristic of each cylinder, a reference velocity that is closest to the desirable velocity and within the range of actuator forces producible by performing PID control for each cylinder, and a reference generative force to be produced by performing the PID control with the reference velocity; and a manipulated variable calculation part that calculates a manipulated variable based on the quasistatic characteristic of each cylinder, the reference generative force, and the reference velocity.

### TECHNICAL FIELD

The present invention relates to a control device and a control method that control a position of a control object driven by a liquid pressure actuator or a force acting on the control object.

### BACKGROUND ART

A control method for automatically shifting, e.g., a bucket or a working device of a machine such as an excavator driven by an oil pressure actuator to a target position has been developed. A response characteristic of a liquid pressure actuator including an oil pressure actuator indicates a strong nonlinearity and greatly varies according to opening and closing of a relief valve. Therefore, it is difficult to achieve an automatic position determining control with a simple control law.

It is difficult to achieve the control with a simple control law also in a case where force control is performed for a machine driven by the liquid pressure actuator, specifically, in a case where admittance control of a force acting on a control object in contact with an external environment is performed, due to the strong nonlinearity for the liquid pressure actuator.

Patent Literature 1 involves simplifying a control algorithm by solving simultaneous equations of a predictive equation for predicting a position and a velocity of a control object in a next timestep based on prior information on a dynamic characteristic of the control object and an equation representing a sliding mode control law to calculate a valve opening degree instruction as a manipulated variable to the liquid pressure actuator.

### CITATION LIST

### Patent Literature

Patent Literature 1: Japanese Unexamined Patent Publication No. 2021-121717

The control method in Patent Literature 1 utilizes the dynamic characteristic of the control object in the calculation of the valve opening degree instruction to the liquid pressure actuator. However, in a case where the prior information on the dynamic characteristic of the control object is inaccurate or a case where there is a time delay in response of the oil pressure actuator, accuracy of the predictive equation cannot be ensured, and therefore a desired control characteristic may not be achieved.

### SUMMARY OF INVENTION

An object of the present invention is to provide a control device and a control method that achieve a high control performance in position control or force control even in a case where prior information on a dynamic characteristic of a control object is inaccurate and a case where there is a time delay in response of a liquid pressure actuator.

A control device according to a first aspect of the present invention includes: a movement instruction part that controls a liquid pressure actuator for driving a machine that is a control object; a desirable velocity calculation part that calculates a desirable velocity to be produced in a next timestep for the machine based on a target position and a current position of the machine; a reference velocity calculation part that calculates a reference velocity and a reference generative force based on a quasistatic characteristic of the liquid pressure actuator, the reference velocity being a target velocity closest to the desirable velocity among target velocities from which actuator forces producible by performing PID control or PD control for the liquid pressure actuator are calculable, and the reference generative force being an actuator force to be produced by performing the PID control or PD control when the reference velocity serves as the target velocity; and a manipulated variable calculation part that calculates a manipulated variable for the liquid pressure actuator based on the quasistatic characteristic of the liquid pressure actuator, the reference generative force, and the reference velocity.

A control method according to a second aspect of the present invention includes: a desirable velocity calculation step of calculating a desirable velocity to be produced in a next timestep for a machine that is a control object and is driven by a liquid pressure actuator, based on a target position and a current position of the machine; a reference velocity calculation step of calculating a reference velocity and a reference generative force based on a quasistatic characteristic of the liquid pressure actuator, the reference velocity being a target velocity closest to the desirable velocity among target velocities from which actuator forces producible by performing PID control or PD control for the liquid pressure actuator are calculable, and the reference generative force being an actuator force to be produced by performing the PID control or PD control when the reference velocity serves as the target velocity; and a manipulated variable calculation step of calculating a manipulated variable for the liquid pressure actuator based on the quasistatic characteristic of the liquid pressure actuator, the reference generative force, and the reference velocity.

### BRIEF DESCRIPTION OF DRAWINGS

FIG. 1 is a schematic diagram showing a configuration of an oil pressure actuator according to a first embodiment of the present invention.

FIG. 2 is a side view briefly showing an excavator according to the first embodiment.

FIG. 3 is a block diagram showing a configuration of a control system according to the first embodiment.

FIG. 4 is a schematic diagram showing how a plurality of the oil pressure actuators is controlled.

FIG. 5 is a flowchart showing a flow of position control according to the first embodiment.

FIG. 6 is an illustration showing a posture of an oil pressure excavator and a path of a target position in numerical examples.

FIG. 7A is a schematic diagram showing a flow of a process in a conventional control law.

FIG. 7B is a schematic diagram showing a flow of a process in a control law according to the first embodiment of the present invention.

FIG. 8 shows results of simulations for the conventional control law and the control law according to the first embodiment of the present invention.

FIG. 9A shows results of simulations for comparing effects of modeling errors under the control law according to the first embodiment of the present invention without regeneration circuit compensation.

FIG. 9B shows results of simulations for comparing the effects of the modeling errors under the control law according to the first embodiment of the present invention with the regeneration circuit compensation.

FIG. 9C shows results of simulations for comparing the effects of the modeling errors under the conventional control law.

FIG. 10 is a block diagram showing a configuration of a control system according to a second embodiment.

FIG. 11 is a functional block diagram showing a configuration of the control system according to the second embodiment.

FIG. 12 is a flowchart showing a flow of force control according to the second embodiment.

FIG. 13 is a schematic diagram showing a configuration of a hydraulic testing machine in numerical examples.

FIG. 14A shows graphs indicating results of a simulation under a stepwise input and a hardness of a contact environment of 50 HS in the numerical examples.

FIG. 14B shows graphs indicating results of a simulation under the stepwise input and a hardness of the contact environment of 65 HS in the numerical examples.

FIG. 14C shows graphs indicating results of a simulation under the stepwise input and a hardness of the contact environment of 70 HS in the numerical examples.

FIG. 15A shows graphs indicating results of a simulation under a sinusoidal input and the hardness of the contact environment of 50 HS in the numerical examples.

FIG. 15B shows graphs indicating results of a simulation under the sinusoidal input and the hardness of the contact environment of 65 HS in the numerical examples.

FIG. 15C shows graphs indicating results of a simulation under the sinusoidal input and the hardness of the contact environment of 70 HS in the numerical examples.

### DESCRIPTION OF EMBODIMENTS

### First Embodiment

A control device and a control method for position control among control devices and methods according to the embodiments of the present invention will be described below with reference to the drawings.

### <Control Algorithm>

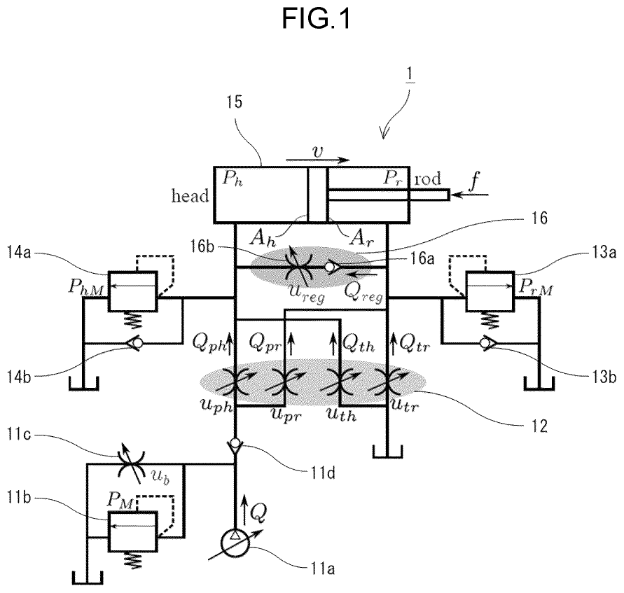

First, a control law according to the embodiment, i.e., a control algorithm for determining a manipulated variable u for a liquid pressure actuator in a case where a machine as a control object is driven by the liquid pressure actuator and the control object is shifted to a target position will be described. Specifically, an oil pressure actuator 1 shown in FIG. 1 is supposed to serve as the liquid pressure actuator.

As shown in FIG. 1, the oil pressure actuator 1 includes an oil pressure pump 11a for providing oil pressure, a pump relief valve 11b, a bleed valve 11c, a pump check valve 11d, main control valves 12 for controlling the oil pressure, a rod-side relief valve 13a, a rod-side check valve 13b, a head-side relief valve 14a, a head-side check valve 14b, and a cylinder 15 actuated by control of the oil pressure. The oil pressure actuator 1 includes a regeneration circuit 16. The regeneration circuit 16 includes a check valve 16a and a flowrate control valve 16b.

### <Mathematical Preliminaries>

The embodiment involves a closed unit ball B and functions represented by Formulae (1), (2), (3), and (4) below.

$$ℬ {=}^{Δ} [ - 1 , 1 ] ⊂ ℝ \qquad ( 1 )$$

$${sat}_{𝒳} ( x ) {=}^{Δ} \{ \begin{matrix}min X & if x < min 𝒳 \\ x & if x ∈ 𝒳 \\ max X & if x > max 𝒳\end{matrix} \qquad ( 2 )$$

$$sgn ( x ) {=}^{Δ} \{ \begin{matrix}x / \vert x \vert & if x \neq 0 \\ ( - 1 , 1 ) & if x = 0\end{matrix} \qquad ( 3 )$$

$$ℛ ( x ) {=}^{Δ} sgn ( x ) \sqrt{\vert x \vert} \qquad ( 4 )$$

Further, a function with a set-valued argument represented by Formula (5) below is used.

$$Φ ( 𝒳 ) = {⋃}_{x ∈ 𝒳} Φ ( x ) \qquad ( 5 )$$

Here, X denotes a real closed interval.

### <Control Law>

The liquid pressure actuator is represented by Formulae (6a), (6b), and (6c) below.

M\dot{v}=f+g (6a)

\dot{p}=v (6b)

f∈Γ(v,u) (6c)

Here, p denotes a position of a control object, v denotes a velocity of the control object, and M denotes mass of the control object.

The control object represented by Formulae above receives an actuator force f and an external force g. The set-valued function Γ represents a quasistatic model of the liquid pressure actuator, and is defined as a set-valued function from a current velocity v and the manipulated variable u as a valve opening degree instruction to the actuator force f. Specific forms of the set-valued function Γ, which is the quasistatic model of the oil pressure actuator 1 driven in a state where the regeneration circuit 16 is eliminated from a hydraulic circuit of the oil pressure actuator 1, i.e., in a state where the regeneration circuit 16 is always closed, are shown by Formula (19) in a known Document 1 (R. Kikuuwe, et al., “A nonsmooth quasi-static modeling approach for hydraulic actuators,” J. Dyn. Sys., Meas., Control, vol. 143, no. 12, p. 1210 02, 2021), and Formula (24) in a known Document 2 (Y. Yamamoto, et al., “A sliding-mode set-point position controller for hydraulic excavators”, IEEE Access, vol. 9, pp. 153735-153749, 2021).

The manipulated variable u∈B, which is the second argument of the function Γ, represents opening degrees of four main control valves 12 shown in FIG. 1. The manipulated variable u and the opening degrees u*∈[0, 1] (*∈{ph, pr, th, tr}) of the main control valves 12 are in a relationship represented by Formula (7) below.

uₚₕ=uₜᵣ=max(0,u), uₚₜ=uₜₕ=−min(0,u) (7)

According to Formula (7) above, a positive control input, which is a manipulated variable u, represents an instruction for extension of the cylinder, and a negative control input, which is a manipulated variable u, represents an instruction for contraction of the cylinder.

The embodiment involves a position control law for the oil pressure actuator, which is represented by Formulae (8a), (8b), (8c), and (8d) below.

\hat{f}=La+K\dot{a}+Dä−g (8a)

\hat{f}∈Γ(vᵣ,sgn(p_{d}−p+H(\dot{p}_{d}−vᵣ))) (8b)

u∈Θ(vᵣ,f̅) (8c)

ä=vₙ−\dot{p} (8d)

Here, K, L, and D denote PID gains, H denotes a time constant, p_{d} denotes a target position, p denotes a current position, vᵣ denotes a reference velocity, u denotes an instruction to the actuator, f\hat{ } denotes a reference generative force of the actuator, and a denotes an integral value of errors in a PID controller. Further, g denotes an estimation value of the external force. The estimation value of the external force may be set as g=0 if unavailable, but a better control performance can be achieved if the estimation value g is available.

The function Θ is an inverse function with respect to the second argument of the set-valued function Γ, and is a set-valued function in a relationship with the set-valued function Γ, the relationship being represented by Formula (9) below.

u∈Θ(v,f)⇔f∈Γ(v,u) (9)

Formula (8a) represents a PID control law based on the velocity p′ and the reference velocity vᵣ. Formula (8b) represents a sliding mode control law with a switching surface represented by Formula (10) below.

α≙p−p_{d}+H(vᵣ−\dot{p}_{d})=0 (10)

In the embodiment, Formula (8a) representing the PID control law and Formula (8b) representing the sliding mode control law are combined. Hereinafter, this approach is referred to as differential algebraic relaxation. Formula (8b) representing the sliding mode control law, of which right-hand side is set-valued, cannot give a unique value, and thus is not appropriate for implementation if used solely; however, this problem can be avoided by the combination with Formula (8a) representing the PID control law, enabling calculation (computation, the same applies hereinafter) of the reference generative force f\hat{ }. Although a symbol such as a dot placed above a sign in each of Formulae is written after the sign in the description, both mean the same.

### <Discrete-Time Algorithm>

A discrete-time control algorithm is considered to implement the control law described above. A discretization of the control law represented by Formulae (8) (Formulae (8a) to (8d)) using the backward Euler method results in Formulae (11) below (Formulae (11a) to (11f)).

\hat{f}ₖ=Laₖ+K(aₖ−aₖ₋₁)/T+D(aₖ−2aₖ₋₁+aₖ₋₂)/T²−gₖ (11a)

\hat{f}ₖ∈Γ(v_{r,k},sgn(p_{d,k}+Hv_{d,k}−pₖ−Hv_{r,k})) (11b)

uₖ∈Θ(v_{r,k},\hat{f}ₖ) (11c)

aₖ=2aₖ₋₁−aₖ₋₂+T²(v_{r,k}−vₖ) (11d)

vₖ=(pₖ−pₖ₋₁)/T (11e)

v_{d,k}=(p_{d,k}−p_{d,k-1})/T (11f)

Here, T denotes a sampling interval, and k∈Z denotes a discrete-time index.

An elimination of v_{r,k} and aₖ from Formula (11b) using Formulae (11a) and (11d) results in Formulae (12) below (Formulae (12a) to (12c)).

\hat{f}ₖ∈Γ(v_{r,k}+\hat{f}ₖ/A,sgn(v_{s,k}−f_{f,k}−\hat{f}ₖ/A)) (12a)

v_{f,k}≙vₖ−((K/T+L)(aₖ₋₁−aₖ₋₂)+Laₖ₋₁−gₖ)/A (12b)

v_{s,k}≙(p_{d,k}+Hv_{d,k}−pₖ)/H (12c)

Here, A=Δ LT²+KT+D (as shown in Formulae 12, =Δ corresponds to a sign of A vertically placed above =).

Here, v_{s,k} can be interpreted as a desirable velocity to be reached in a next step according to the sliding mode control law. Also, v_{r,k} can be interpreted as a provisional target velocity to cause the generative force by the liquid pressure actuator to be zero when the PID control law is performed for the liquid pressure actuator.

A known Document 3 (R. Kikuuwe, Y. Yamamoto, and B. Brogliato, “Implicit implementation of nonsmooth controllers to nonsmooth actuators,” IEEE Trans. Autom. Control, 10.1109/TAC.2022.3163124, 2022) shows that Formulae (13) below holds.

f∈Γ(v_{b}+ηf,sgn(vₐ−ηf))⇔f=sat_{Γ}_{ₛ}_{(η,v}_{_{b}}_{,β)}(vₐ/η) (13)

Formula (12a) can be rewritten as Formula (14) below by using Formula (13).

\hat{f}=sat_{Γ}_{ₛ}_{(1/A,v}_{_{f,k}}_{,β)}(A(v_{s,k}−v_{f,k})) (14)

Thus, an algorithm for obtaining a control input uₖ from a state {pₖ, vₖ, p_{d,k}, v_{d,k}}, which is represented by Formulae (15) below (Formulae (15a) to (15f)), is obtained.

v_{s,k}:=(p_{d,k}+Hv_{d,k}−pₖ)/H (15a)

v_{f,k}:=vₖ−((K/T+L)(aₖ₋₁−aₖ₋₂)+Laₖ₋₁−gₖ)/A (15b)

\hat{f}ₖ:=sat_{Γ}_{ₛ}_{(1/A,v}_{_{f,k}}_{,β)}(A(v_{s,k}−v_{f,k})) (15c)

v_{r,k}:=v_{f,k}+\hat{f}ₖ/A (15d)

aₖ:=2aₖ₋₁−aₖ₋₂+T²(v_{r,k}−vₖ) (15e)

uₖ:=Θₛ(v_{r,k},\hat{f}ₖ) (15f)

Here, the function Γₛ and the function Θₛ are single-valued functions that have a relationship with the function Is and the function Θₛ as shown in Formulae (16) and (17) below.

f=Γₛ(η,v,u)⇔f∈Γ(v+ηf,u) (16)

Θₛ(v,f)∈Θ(v,sat_{Γ(v,β)}(f)) (17)

As described above, the set-valued function Γ can be obtained from a quasistatic characteristic (relationship between the velocity v in a steady state, the generative force f, and the manipulated variable u representing the valve opening degree instruction) of the liquid pressure actuator. The set-valued function Θ can be obtained from the set-valued function Γ by using Formula (9). The single-valued function Γₛ and the single-valued function Θₛ can be obtained by using these relationships, and Formulae (16) and (17). Specific forms of the single-valued function Γₛ and the single-valued function Θₛ for the oil pressure actuator 1 driven in the state where the regeneration circuit 16 is eliminated from the hydraulic circuit of the oil pressure actuator 1 shown in FIG. 1, i.e., in the state where the regeneration circuit 16 is always closed are shown by Formulae (34) and in Section III.C in the known Document 2.

A pair {fₖ\hat{ }, v_{r,k}} in real numbers for a generative force fₖ producible in the oil pressure actuator 1 and a target velocity v_{r,k} to produce the generative force fₖ at a time k satisfies two Formulae (18a) and (18b) below.

v_{r,k}=v_{f,k}+\hat{f}ₖ/A (18a)

\hat{f}ₖ∈Γ(v_{r,k},β) (18b)

Although an infinite number of pairs {fₖ\hat{ }, v_{r,k}} satisfy Formulae (18) shown above, the pair {fₖ\hat{ }, v_{r,k}} obtained from Formulae (15b), (15c), and (15d) has v_{r,k} closest to v_{s,k} among the infinite number of pairs. In other words, Formulae (15b), (15c), and (15d) represent a step (reference velocity calculation step) of calculating the reference velocity v_{r,k} and the reference generative force fₖ\hat{ } based on the quasistatic characteristic of the liquid pressure actuator, the reference velocity being a target velocity closest to the desirable velocity v_{s,k} among target velocities v_{f,k} from which actuator forces producible by performing PID control for the oil pressure actuator 1 are calculable, and the reference generative force being an actuator force to be produced by performing the PID control when the reference velocity v_{r,k} serves as the target velocity v_{f,k}.

If L=0 in Formulae (15) representing the algorithm, aₖ is caused to become infinite, causing an issue. For this case, Formulae (15) representing the algorithm can be modified as Formulae (19a) to (19f) below by using a new variable ek defined as eₖ=(aₖ−aₖ₋₁)/T.

v_{s,k}:=(p_{d,k}+Hv_{d,k}−pₖ)/H (19a)

v_{f,k}:=vₖ−(Keₖ₋₁−gₖ)/A (19b)

\hat{f}ₖ:=sat_{Γ}_{ₛ}_{(1/A,v}_{_{f,k}}_{,β)}(A(v_{s,k}−v_{f,k})) (19c)

v_{r,k}:=v_{f,k}+\hat{f}ₖ/A (19d)

eₖ:=eₖ₋₁+T(v_{r,k}−vₖ) (19e)

uₖ:=Θₛ(v_{r,k},\hat{f}ₖ) (19f)

Here, A=Δ KT+D (=A corresponds to a sign of A vertically placed above =).

The algorithm represented by Formulae (19) above can be derived by replacing a′ with e and setting L=0 in Formulae (8), performing discretization by the backward Euler method, and following a similar procedure for deriving Formulae (15) above. Thus, the PID control in Formulae (15) can be replaced with a PD control in Formulae (19) where the integral gain L=0.

The conventional control law in the known Document 2, which is based on a quasistatic model similarly to the embodiment, involves a double-implicit implementation scheme to deal with set-valuedness of the sliding mode control law. In the double-implicit implementation scheme, both the control law and a dynamic characteristic model of a control object are discretized by the backward Euler method and combined to construct a control algorithm. The control method based on the differential algebraic relaxation according to the embodiment, which does not require the dynamic characteristic model for the implementation, is more robust against modeling errors than the conventional control method. Additionally, sensitivity to the modeling errors and deadtime can be adjusted by adjusting a gain of the PID controller connected by the differential algebraic relaxation.

As shown in Formulae (19) representing the algorithm, in the position control according to the embodiment, the desirable velocity v_{s,k} to be produced in the liquid pressure actuator in the next timestep is calculated based on the target position p_{d,k} and the current position pₖ of the liquid pressure actuator, specifically, based on the target position p_{d,k}, the current position pₖ, the target velocity v_{d,k} obtained from these positions, and the current velocity vₖ (the desirable velocity calculation step, Formula (19a)). The reference velocity v_{r,k} and the reference generative force fₖ\hat{ } are then calculated based on the quasistatic model F of the liquid pressure actuator, the reference velocity being a target velocity closest to the desirable velocity v_{s,k} among target velocities v_{f,k} from which actuator forces f producible by performing PID control or PD control for the liquid pressure actuator are calculable, and the reference generative force being an actuator force to be produced by performing the PID control or PD control when the reference velocity v_{r,k} serves as the target velocity (the reference velocity calculation step, Formulae (19b) to (19e)). Further, the manipulated variable uₖ for the liquid pressure actuator is calculated based on the quasistatic model Γ of the liquid pressure actuator, and the calculated reference generative force fₖ\hat{ } and reference velocity v_{r,k} (the manipulated variable calculation step, Formula (19f)).

### <Compensation for Effect of Regeneration Circuit>

The oil pressure actuator 1 includes the regeneration circuit 16 as shown in FIG. 1. The regeneration circuit 16 transfers hydraulic liquid (hydraulic oil) from a rod-side chamber to a head-side chamber by use of potential energy of a link. For a cross-sectional area Aᵣ of the rod-side chamber, a cross-sectional area Aₕ of the head-side chamber, and A⁻=(Aᵣ+Aₕ)/2, a pressure difference caused by the external force g between the rod-side chamber and the head-side chamber can be approximated to g/A⁻. Since a flowrate in the flowrate control valve 16b is proportional to the square root of the pressure difference between the chambers, an estimation value of the flowrate q_{reg} of the hydraulic oil flowing through the regeneration circuit can be calculated by Formula (20) below.

q_{reg}=max(c_{reg}u_{reg}R(g/Â),0) (20)

Here, u_{reg} denotes an opening degree of the flowrate control valve 16b of the regeneration circuit 16. The coefficient c_{reg} is defined as C_{reg}a_{reg}√2/ρ, where ρ denotes mass density of the hydraulic oil, a_{reg} denotes a maximum opening area of the flowrate control valve 16b, and C_{reg} denotes a discharge coefficient.

An increase v_{reg} in a cylinder velocity due to the flowrate q_{reg} in the regeneration circuit 16 can be calculated as v_{reg}=q_{reg}/Aₕ. The variable v_{reg} indicates a non-negative value due to an effect of the check valve 16a of the regeneration circuit 16. An expansion of the control law represented by Formulae (8) based on the increase v_{reg} in the cylinder velocity for compensation for an effect of the regeneration circuit 16 results in a control law represented by Formulae (21a), (21 b), and (21c) below.

\hat{f}=La+K\dot{a}+Dä−g (21a)

\hat{f}∈Γ(vᵣ,sgn(p_{d}−p+H(\dot{p}_{d}−vᵣ−v_{reg}))) (21b))

u∈Θ(vᵣ,\hat{f}) (21c)

Due to an introduction of the variable v_{reg} described above, the switching surface is represented by: p_{d}−p+H(p_{d}′−vᵣ−v_{reg})=0, in a case where the hydraulic oil is transferred to the head-side chamber through the regeneration circuit 16. Thus, the switching surface is reached at a velocity reduced by v_{reg} compared to a case without the compensation. Therefore, a control that prevents an excessive increase in the velocity can be performed.

An algorithm for implementation of the control law involving the variable v_{reg} can be obtained by applying the similar procedure for deriving the algorithm represented by Formulae (15) to the control law represented by Formulae (21) and performing the discretization. The algorithm is derived by replacing Formula (15a) of the algorithm represented by Formulae (15) with Formula (22) below.

v_{s,k}:=(p_{d,k}+H(v_{d,k}−v_{reg,k})−pₖ)/H (22).

A value of the variable v_{reg,k} can be computed by using Formula (20) for each timestep relevant to computation. In the computation, gravity acting on the cylinder 15, which is derived from a joint angle and mass of the link, can be used as the external force g.

### <Configuration of Control System>

In the embodiment, a specific example of a control system configured to perform position control of a bucket of an excavator driven by a plurality of oil pressure actuators will be described.

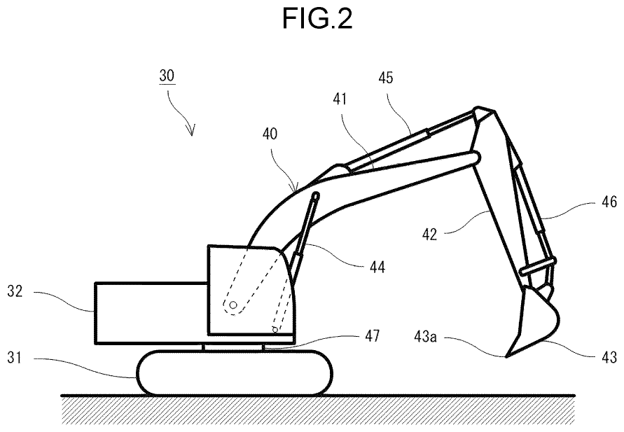

A control unit 50 serving as a position control device according to the embodiment is installed in an excavator 30 as shown in FIG. 2 and controls movement of the excavator 30.

The excavator 30 includes a lower traveling body 31, an upper slewing body 32, and a working device 40. The lower traveling body 31 causes the excavator 30 to travel, which is, for example, a crawler. The upper slewing body 32 is slewably attached to the lower traveling body 31 via a slewing motor 47. The upper slewing body 32 is provided with, e.g., a cab that allows an operator to operate the excavator 30, and the working device 40.

The working device 40 includes a boom 41 rotatably attached to the upper slewing body 32, an arm 42 rotatably attached to the boom 41, and a bucket 43 rotatably attached to the arm 42 for performing, e.g., excavation.

The working device 40 includes a boom cylinder 44 that is connected to the upper slewing body 32 and the boom 41 and moves the boom 41, an arm cylinder 45 that is connected to the boom 41 and the arm 42 and moves the arm 42, a bucket cylinder 46 that is connected to the arm 42 and the bucket 43 and moves the bucket 43, and the slewing motor 47 that is connected to the lower traveling body 31 and the upper slewing body 32 and moves the upper slewing body 32. Each of the boom cylinder 44, the arm cylinder 45, the bucket cylinder 46, and the slewing motor 47 (hereinafter, also referred to as actuators 44 to 47, respectively) is an oil pressure actuator driven by oil pressure.

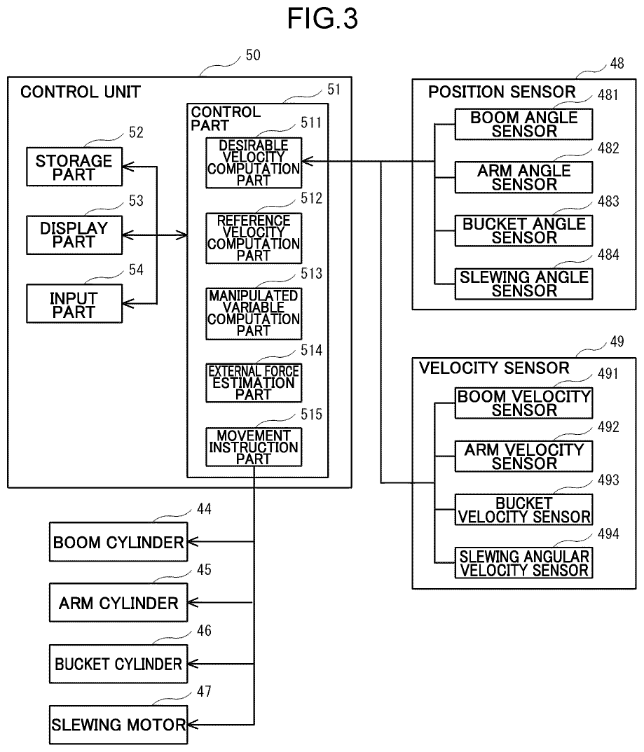

The control unit 50 is installed in the excavator 30, and includes a control part 51, a storage part 52, a display part 53, and an input part 54 as shown in the block diagram of FIG. 3. The control unit 50 is connected with, e.g., a position sensor 48, a velocity sensor 49, and the actuators 44 to 47, and controls movement of each portion of the excavator 30.

The control part 51 is a computer device including, e.g., a central processing unit (CPU), a read only memory (ROM), and a random access memory (RAM), and controls movement of the excavator 30. The control part 51 performs each function as the control part 51 shown in FIG. 3 by loading various operation programs and data stored in the ROM of the control part 51 and the storage part 52 into the RAM to cause the CPU to operate. Thus, the control part 51 operates as a desirable velocity computation part 511 (desirable velocity calculation part), a reference velocity computation part 512 (reference calculation computation part), a manipulated variable computation part 513 (manipulated variable calculation part), an external force estimation part 514, and a movement instruction part 515.

The desirable velocity computation part 511, the reference velocity computation part 512, and the manipulated variable computation part 513 calculate a manipulated variable u for each of the actuators 44 to 47 for moving the working device 40, based on measured values output by the position sensor 48 and the velocity sensor 49, and a target position of the bucket 43, specifically, a target position of a leading end of the bucket 43 (hereinafter, referred to as a bucket leading end 43a) corresponding to a predetermined portion of the excavator 30.

The external force estimation part 514 estimates a magnitude of an external force acting on each of the actuators 44 to 47. How an external force is estimated is not particularly limited; for example, it may be estimated based on an output from, e.g., a sensor (not shown) provided to each of the actuators 44 to 47.

The movement instruction part 515 controls each of the actuators 44 to 47 based on the manipulated variables u calculated by the manipulated variable computation part 513 to move the upper slewing body 32, the boom 41, the arm 42, and the bucket 43.

The storage part 52 includes a non-volatile memory such as a hard disk or a flash memory, and stores, e.g., various setting parameters and a control algorithm for calculating the manipulated variable u.

The display part 53 includes a displaying device such as a liquid-crystal or organic electro-luminescence (EL) panel, and displays, e.g., the various setting parameters and detection values by the position sensor 48 and the velocity sensor 49. The display part 53 according to the embodiment is a liquid crystal panel provided in the cab of the excavator 30.

The input part 54 is an input device for inputting the various setting parameters for moving the excavator 30, e.g., the target position of the bucket leading end 43a. The input part 54 includes, e.g., a touch panel provided on the display part 53.

The position sensor 48 is a sensor that detects a position of the working device 40 of the excavator 30 that is a control object. The position sensor 48 according to the embodiment includes a slewing angle sensor 484 that detects an angle of the upper slewing body 32, a boom angle sensor 481 that detects an angle of the boom, an arm angle sensor 482 that detects an angle of the arm, and a bucket angle sensor 483 that detects an angle of the bucket. The control part 51 calculates lengths of the boom cylinder 44, the arm cylinder 45, and the bucket cylinder 46 (hereinafter, also referred to as cylinders 44 to 46, respectively) and an angle of the slewing motor 47 from the angle of each portion of the working device 40 detected by the boom angle sensor 481, the arm angle sensor 482, the bucket angle sensor 483, and the slewing angle sensor 484, and performs position control of the bucket leading end 43a based on the calculated length of each of the cylinders 44 to 46 and the angle of the slewing motor 47.

The velocity sensor 49 is a sensor that detects a velocity of each portion of the working device 40. The velocity sensor 49 according to the embodiment includes a slewing angular velocity sensor 494 that detects an angular velocity of the upper slewing body 32, a boom velocity sensor 491 that detects an extension and contraction velocity of the boom cylinder, an arm velocity sensor 492 that detects an extension and contraction velocity of the arm cylinder, and a bucket velocity sensor 493 that detects an extension and contraction velocity of the bucket cylinder.

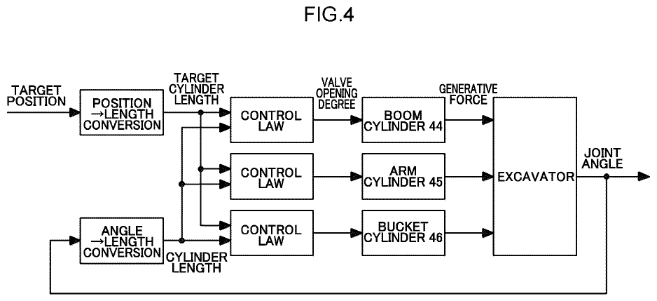

A position control process for the bucket leading end 43a by the control unit 50 according to the embodiment will be described below. An exemplary control algorithm to calculate a manipulated variable u for each cylinder 44 to 46 serving as the oil pressure actuator as shown in the block diagram of FIG. 4 will be described. Hereinafter, the embodiment is assumed to involve the cylinders 44 to 46 only, but is not limited to this. A controller may be configured to additionally involve a slewing angle of the upper slewing body 32, based on a coordinates of the target position p_{d}, to perform the position control of the bucket leading end 43a. Specifically, as shown in FIG. 3, the position control of the bucket leading end 43a may be performed by moving the slewing motor 47 serving as a liquid pressure actuator based on the slewing angle sensor 484 as a position sensor 48 and the slewing angular velocity sensor 494 as a velocity sensor 49, and by combining movements of the boom 41, the arm 42, and the bucket 43.

In the control algorithm of the present invention, the control part 51 calculates a manipulated variable u for each of the cylinders 44 to 46 based on, e.g., a target position, a desired behavior, a current position, and a current velocity of a given control object. The desired behavior is represented by, e.g., the time constant, which involves convergence of movement of the control object to the target position.

### <Flow of Control>

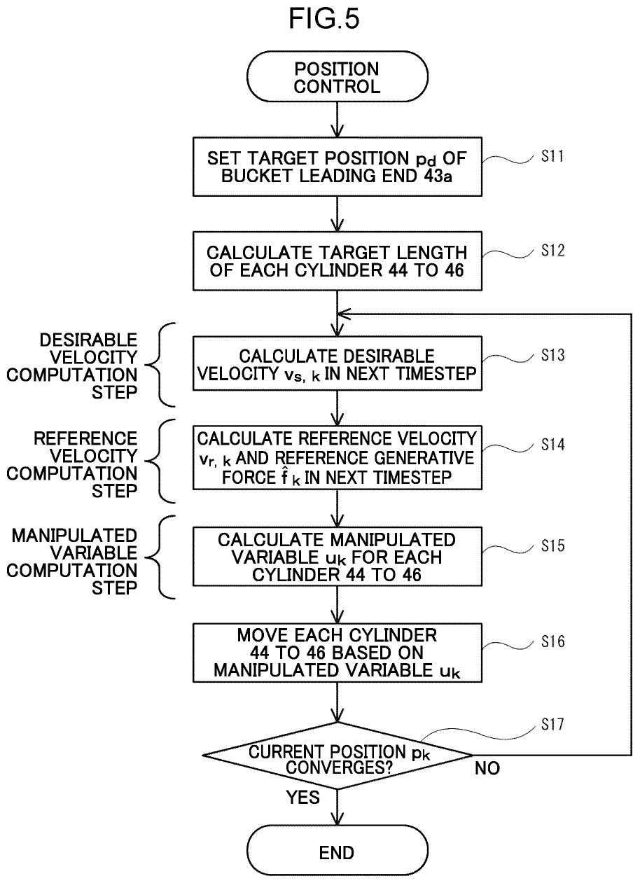

A specific flow of the position control of the bucket leading end 43a of the excavator 30 will be described with reference to the flowchart of FIG. 5.

The operator of the excavator 30 inputs and sets a target position p_{d} of the bucket leading end 43a through the input part 54 (Step S11). A coordinate of the target position p_{d} may be input through the input part 54 including the touch panel, or a coordinate of the bucket leading end 43a manually shifted with a control lever may be set as the target position p_{d}. A coordinate on a planned surface prestored in the storage part 52 may be read out and set as the target position p_{d}.

The operator inputs and sets parameters such as the time constant H representing the desired behavior. The parameters may be set by reading out values prestored in the storage part 52.

The control part 51 calculates a target length of each of the cylinders 44 to 46 at the target position p_{d} by inverse kinematics from the input target position p_{d} (Step S12). As shown in FIG. 4, each of the cylinders 44 to 46 is controlled to extend or contract such that the lengths of the cylinders 44 to 46 become the respective target lengths, so that the position control of the bucket leading end 43a is performed.

The desirable velocity computation part 511 of the control part 51 calculates the desirable velocity v_{s,k} to be produced in the next timestep, which is the desirable velocity computation step (Step S13). Specifically, the control part 51 acquires angle data of each portion of the working device 40 from the boom angle sensor 481, the arm angle sensor 482, and the bucket angle sensor 483 (hereinafter, also referred to as angle sensors 481 to 483, respectively). The control part 51 calculates a current position pₖ representing a length of each of the cylinders 44 to 46 based on the acquired angle data. The control part 51 calculates the desirable velocity v_{s,k} of each of the cylinders 44 to 46 based on the calculated current position pₖ (m), the set target position p_{d,k} (m), the target velocity v_{d,k} (m/s), the time constant H (s), and Formula (15a) or (22). The control period is, e.g., 10 ms (milliseconds), but is not particularly limited.

Next, the reference velocity computation part 512 of the control part 51 calculates the reference velocity v_{r,k} and the reference generative force fₖ^{A} in the next timestep, based on the current velocity vₖ (m/sec), the set PID gains K, L, and D, the control period T (see), and Formulae (15b) to (15e) or Formulae (19b) to (19e), which is the reference velocity computation step (Step S14). Specifically, the reference velocity computation part 512 acquires the current velocity vi of each of the cylinders 44 to 46 from the boom velocity sensor 491, the arm velocity sensor 492, and the bucket velocity sensor 493. The reference velocity computation part 512 then calculates the reference velocity v_{r,k} and the reference generative force fₖ\hat{ }, based on the quasistatic model Γ of the liquid pressure actuator, the reference velocity being a target velocity closest to the desirable velocity v_{s,k} among target velocities v_{f,k} from which actuator forces f producible by performing PID control or PD control for the liquid pressure actuator are calculable, and the reference generative force being an actuator force to be produced by performing the PID control or PD control when the reference velocity v_{r,k} serves as the target velocity.

Next, the manipulated variable computation part 513 of the control part 51 calculates the manipulated variable uₖ for each of the cylinders 44 to 46, which is the manipulated variable computation step (Step S15). Specifically, the manipulated variable computation part 513 calculates the manipulated variables uₖ, based on the reference velocity v_{r,k} and the reference generative force fₖ\hat{ } calculated in Step S14, and the quasistatic model Γ of the liquid pressure actuator (Formulae (15f), (17)).

The movement instruction part 515 of the control part 51 outputs the calculated manipulated variables uₖ to the respective cylinders 44 to 46 to move the boom 41, the arm 42, and the bucket 43 so that the bucket leading end 43a is shifted (Step S16).

When the next timestep is reached, the control part 51 acquires a new current position pₖ of each of the cylinders 44 to 46 from the position sensor 48. In a case where a difference between the acquired current position pₖ and the target position p_{d,k} is not larger than a certain preset threshold (YES in Step S17), the control part 51 ends the position control.

In a case where the difference between the acquired current position pₖ and the target position p_{d,k} is larger than the certain preset threshold (NO in Step S17), the control part 51 returns to Step S13, i.e., the desirable velocity computation step. The control part 51 then calculates manipulated variables uₖ in the timestep based on the control algorithm, and shifts the bucket leading end 43a. The control part 51 repeats this to perform the position control for causing the position of the bucket leading end 43a to reach the target position p_{d}.

As described above, in the control device and the control method for the position control according to the embodiment, the reference velocity and the actuator force are calculated by combining the PID control law or the PD control law that causes the velocity of the control object to follow the reference velocity with the sliding mode control law, and the manipulated variable for the liquid pressure actuator is calculated based on the quasistatic characteristic of the liquid pressure actuator. Therefore, a control independent of the dynamic characteristic model of the control object can be performed. Accordingly, a high control performance can be achieved even in a case where prior information on a dynamic characteristic of a control object is inaccurate and a case where there is a time delay in response of a liquid pressure actuator.

### NUMERICAL EXAMPLES

Simulations of the position control of an oil pressure actuator based on the control law according to the embodiment will be described below. In the examples, the simulations were run by using a realtime simulator for a 13 ton-class oil pressure excavator. In the examples, a position of an arm leading end was controlled by applying the control law according to the embodiment to actuators for each axis by use of kinematics. A sampling interval for the realtime simulator was 0.1 ms, and a sampling interval for a controller was 10 ms. The realtime simulator and the controller were connected with each other by User Datagram Protocol/Internet Protocol (UDP/IP), and were capable of transmitting and receiving, e.g., joint angle information and a control input to and from each other.

A generative force of a cylinder in the realtime simulator was calculated based on the quasistatic model of the oil pressure actuator disclosed in the known Document 1 described above. A generative force of the arm cylinder was calculated based on a quasistatic model covering the regeneration circuit disclosed in the known Document 1. In the examples, a filter represented by Formula (23) below was interposed between the actuator model and the controller to simulate a dynamic characteristic of the oil pressure actuator and deadtime in the oil pressure actuator.

$${u}_{f} = {ℒ}^{- 1} [ \frac{{ω}_{0}^{2} {e}^{- {T}_{d} s} ℒ [ u ]}{{s}^{2} + 2 {ζω}_{0} s + {ω}_{0}^{2}} ] \qquad ( 23 )$$

Here, u_{f} denotes a control input after filtering. The deadtime T_{d}, the cutoff frequency ω₀, and the damping ratio (were set as T_{d}=300 msec, ω₀=94.2 rad/sec, and ζ=1, respectively.

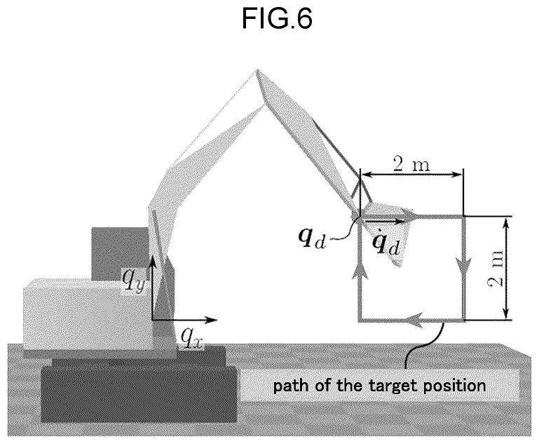

FIG. 6 shows a posture of the excavator 30 and a path of a target position q_{d}. The target position q_{d} and a rate of change of the target position q_{d} with respect to time are as represented by Formula (24) below; the rate of change of the target position q_{d} with respect to time was set to be constant.

q_{d}≙[qₓ,q_{y}]^{T},∥\dot{q}_{d}∥=0.5 m/s (24)

In the examples, parameters for the boom 41 and the arm 42 of the excavator 30 were set as K=3×10⁵ N/m, B=3×10⁵ N·s/m, and H=1.0 s. Further, parameters of the actuator model in the control law were set to have the same values as parameters of the control object.

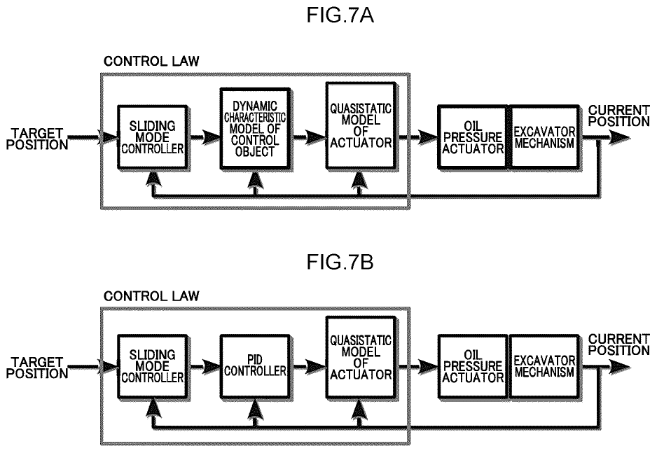

Additionally, control simulations for comparing the control method according to the embodiment and the conventional control method were run under the same conditions. Specifically, a control law A, which is a conventional sliding mode control law based on double-implicit implementation as shown in FIG. 7A (control law according to the known Document 2), and a control law B, which is the PID control law according to the embodiment as shown in FIG. 7B, were used. The control law A involves a deadtime compensator; therefore, simulations with the look-ahead time T_{d}\hat{ } being set to 300 ms (=T_{d}), 150 ms, and 0 ms were run. The time constant H indicating the slope of the switching surface was set to 1.0 s.

The control law B is represented by Formulae (25) below (Formulae (25a) and (25b)).

\hat{f}=Kₚ(p_{d}−p)+K_{d}(\dot{p}_{d}−\dot{p})+Kᵢ∫(p_{d}−p) (25a)

u=Θₛ(v,\hat{f}) (25b)

Here, the proportional gain Kₚ, the derivative gain K_{d}, and the integral gain Kᵢ were set to 3×10⁸ N/m, 3×10⁸ N·s/m, and 0, respectively. The values of these gains result from adjustment by trial and error with repeated simulations.

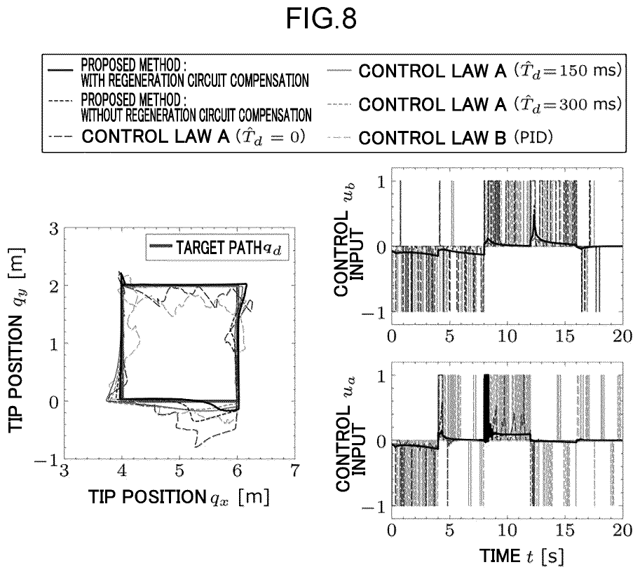

FIG. 8 shows results of the simulations. As shown in FIG. 8, the control method according to the embodiment with regeneration circuit compensation (a proposed method in the drawing) achieves the best results with smaller errors between the target position and the position of the arm leading end (tip position in FIG. 8, and similarly in subsequent drawings) over the entire path. The control method according to the embodiment without the regeneration circuit compensation (control law B) causes large errors due to the effect of the regeneration circuit, during vertical lowering and horizontal pulling when the regeneration circuit opens.

The control law A always causes errors in the horizontally pulling, and causes the tip position to always oscillate if the look-ahead time T_{d}\hat{ }=0 (without deadtime compensation). The control law B also causes the oscillation over the entire path.

### <Examination of Effects of Modeling Errors>

Simulations for examining an effect of a parametric error in the model of the oil pressure actuator on control performance were run. An error randomly selected in {−20%, 0, +20%} was given to each parameter of the control law with respect to values such as relief pressure and the discharge coefficient in the simulator, and 100 trials were performed. To make a comparison, similar simulations were run for the control method according to the embodiment and the control law A based on the quasistatic model of the oil pressure actuator.

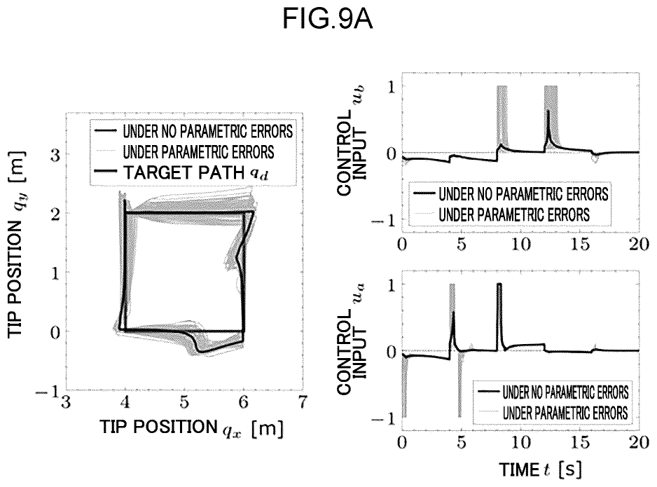

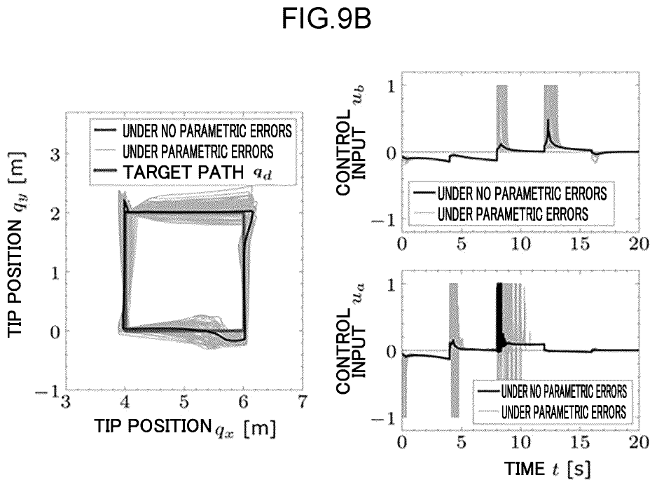

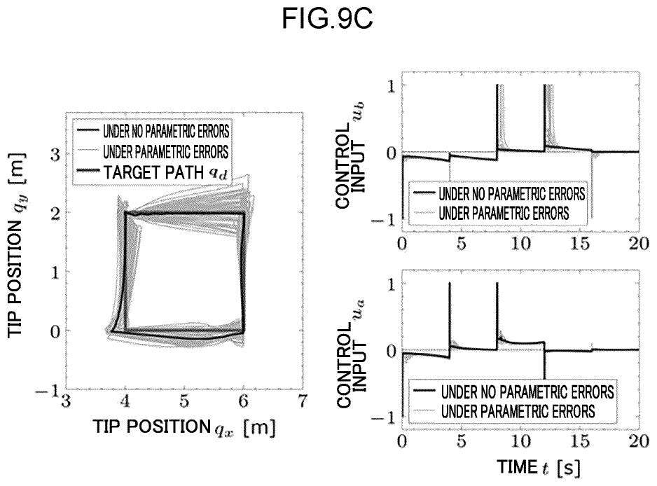

FIG. 9A, FIG. 9B, and FIG. 9C show results of the simulations. A comparison between FIG. 9C for the control law A, and FIG. 9A for the control law B without the regeneration circuit compensation and FIG. 9B with the regeneration circuit compensation shows that paths resulting from the simulations (paths under the parametric errors) in FIG. 9A and FIG. 9B come closer to a desirable path under no parametric errors. This shows that the control performance of the control method according to the embodiment varies little with respect to the parametric errors. The results seem to be ascribed to the fact that the control method according to the embodiment is independent of the dynamic characteristic model of the control object, i.e., has low model dependence. The control law A reflected the effects of the parametric errors more largely, seemingly because the control law involves the deadtime compensation based on the quasistatic model and the dynamic characteristic model of the control object. A comparison between FIG. 9A and FIG. 9B shows that a compensation for the effect of the regeneration circuit even under the parametric errors enables a tip path to come closer to the path of the target position q_{d}.

As described above, the control device and the control method for the position control according to the embodiment involve performing the position control based on the sliding mode control algebraically connected with PID control or PD control and are independent of the dynamic characteristic model of the control object, and thus are hardly affected by, e.g., the parametric errors and the deadtime. Therefore, even an oil pressure actuator with a long deadtime can be controlled appropriately. The control device and the control method, which are based on the quasistatic model of the oil pressure actuator, can deal with the strong nonlinearity of the oil pressure actuator.

Additionally, the control device and the control method according to the embodiment, which involve the expansion for compensating for the effect of the regeneration circuit, are applicable to a liquid pressure actuator having a regeneration circuit.

In the embodiment, the extension and contraction velocity of each of the cylinders 44 to 46 is measured with the velocity sensor 49, but this is not the only way. For example, the control part 51 may calculate the velocity of each of the cylinders 44 to 46 based on the angle data measured by the respective angle sensors 481 to 483.

### Second Embodiment

In the first embodiment above, the position control of the control object driven by the liquid pressure actuator is described. A control law similar to the first embodiment can be used to perform force control of the control object. In the second embodiment, a control device and a control method for force control of a control object driven by a liquid pressure actuator will be described.

Specifically, a force control device and a force control method will be described with an exemplary admittance control of the control object driven by the same oil pressure actuator 1 in the first embodiment. A control system according to the embodiment is different from the first embodiment in that the control system includes a feedback loop for performing the force control and a control part 51′ includes a reference position computation part 516 (reference position calculation part) to achieve this. The other constituents, which are the same as those in the first embodiment, are denoted by the same reference numerals, and the description thereof will be omitted.

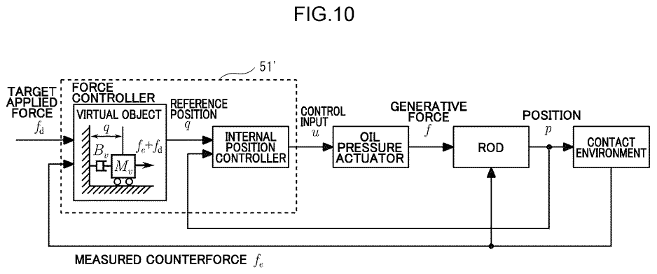

As shown in the block diagram of FIG. 10, the control system according to the embodiment performs the admittance control of movement of the oil pressure actuator 1 based on inputs of a measured value of a force fₑ (hereinafter, also referred to as a counterforce) applied to the oil pressure actuator 1 as the control object by an environment and a target applied force f_{d} that is a target value of a force applied to the environment by the oil pressure actuator 1. As shown in FIG. 10, the admittance control according to the embodiment is force control based on the position control. Specifically, in the admittance control according to the embodiment, an internal position controller that performs the position control according to the first embodiment controls and causes a position p of a rod of the oil pressure actuator 1 as the control object to follow a position q of a virtual object having a target dynamic characteristic of the control object. The target dynamic characteristic of the virtual object includes a dynamic characteristic defined by target inertia and target viscosity of the control object. The virtual object according to the embodiment is represented as a mass damper system obtained by modeling the dynamic characteristic of the oil pressure actuator 1. The virtual object is assumed to receive the target applied force f_{d}, and the measured counterforce fₑ which is a force that the oil pressure actuator 1 receives from a rigid external environment due to a contact between the control object and the environment.

A control law according to the embodiment, i.e., a control algorithm for determining a manipulated variable u for a liquid pressure actuator in a case where a machine as a control object is driven by the liquid pressure actuator and a force caused by a contact between the control object and a rigid environment is controlled will be described below.

### <Mathematical Preliminaries>

The embodiment involves a function represented by Formula (26) below, which is referred to as a normal cone.

$${𝒩}_{[ a , b ]} ( x ) {=}^{Δ} \{ \begin{matrix}( - ∞ , 0 ] & if x = a \\ 0 & if x ∈ [ a , b ] \\ [ 0 , ∞ ) & if x = b \\ ∅ & if x < a ∨ x > b\end{matrix} \qquad ( 26 )$$

### <Control Law>

The liquid pressure actuator as the control object is represented by Formulae (27) (Formulae (27a), (27b), and (27c)) below.

M\dot{v}=f+fₑ+g (27a)

\dot{p}=v (27b)

f∈Γ(v,u) (27c)

Here, p denotes a position of the control object, v denotes a velocity of the control object, and M denotes mass of the control object.

The control object represented by Formulae above receives the generative force f of the actuator, the external force (disturbance) g, and the counterforce fₑ from the environment. The set-valued function Γ represents the same quasistatic model of the liquid pressure actuator as the first embodiment, and is defined as a set-valued function from the current velocity v and the manipulated variable u as the valve opening degree instruction to the generative force f of the actuator. The control input u∈B determines the opening degree of the flowrate control valve. The flowrate control valve is opened to generate an oil flow in the liquid pressure actuator in a direction to cause the liquid pressure actuator to extend if u>0 or in a direction to cause the liquid pressure actuator to contract if u<0. M may not be already known, and p can be acquired by a position sensor.

The embodiment involves an admittance control law represented by Formulae (28) below.

f_{d}=fₑ∈Mᵥ\ddot{q}=Bᵥ\dot{q}=N_{[-v}_{ₘ}_{,v}_{_{m]}}(\dot{q}) (28a)

\hat{f}=K(pᵣ−p)+B(\dot{p}ᵣ−\dot{p})−ĝ (28b)

\hat{f}∈Γ(\dot{p}ᵣ,sgn(q−p+H(\dot{q}−\dot{p}ᵣ)) (28c)

u∈Θ(\dot{p}ᵣ,f̅) (28d)

Here, g\hat{ } denotes an estimation value of the disturbance, and q, Bᵥ, and Mᵥ denote a position of a rod, viscosity, and mass of the virtual object, respectively. Formula (28a) represents a dynamic characteristic of the virtual object driven by the target applied force f_{d} and the measured counterforce fₑ from the environment. The third term N_{[-vm, vm]} (q′) on the right-hand side of Formula (28a) has an effect of limiting the velocity q′ of the virtual object within an interval [−vₘ, vₘ], due to the definition of the normal cone represented by Formula (26). Formulae (28b) to (28d) serve as a position controller that causes the position p of the control object to follow the position q of the virtual object, and represent a control law similar to that of the position controller according to the first embodiment. The position controller has adjustable parameters including PID gains K, B and the time constant H.

### <Discrete-Time Algorithm>

The algorithm for calculating from {f_{d,k}, f_{e,k}, pₖ, gₖ\hat{ }} a control input uₖ from a force controller according to the embodiment to the liquid pressure actuator is obtained by following the similar procedure including the discretization to the first embodiment, and represented by Formulae 29 below.

$${υ}_{q , k} := {sat}_{[ - {υ}_{m} , {υ}_{m} ]} ( \frac{{M}_{υ} {υ}_{q , k - 1} + ( {f}_{d , k} + {f}_{e , k} ) T}{{M}_{υ} + {B}_{υ} T} ) \qquad ( 29 a )$$

$${q}_{k} := {q}_{k - 1} + {υ}_{q , k} T \qquad ( 29 b )$$

$${υ}_{k} := ( {p}_{k} - {p}_{k - 1} ) / T \qquad ( 29 c )$$

$${υ}_{s , k} := ( {q}_{k} - {p}_{k} + H {υ}_{q , k} ) / H \qquad ( 29 d )$$

$${υ}_{f , k} := {υ}_{k} - ( K {e}_{k - 1} - {\hat{g}}_{k} ) / A \qquad ( 29 e )$$

$${\hat{f}}_{k} := {sat}_{{Γ}_{s} ( 1 / A , {υ}_{f , k ,} ℬ )} ( A ( {υ}_{s , k} - {υ}_{f , k} ) ) \qquad ( 29 f )$$

$${υ}_{r , k} := {υ}_{f , k} + {\hat{f}}_{k} / A \qquad ( 29 g )$$

$${e}_{k} := {e}_{k - 1} + ( {υ}_{r , k} - {υ}_{k} ) T \qquad ( 29 h )$$

$${u}_{k} := {Θ}_{s} ( {υ}_{r , k ,} {\hat{f}}_{k} ) \qquad ( 29 i )$$

Here, A=Δ KT+B, k denotes the discrete-time index, and T denotes the sampling interval (the sign of =Δ is as described above).

As shown in Formulae (29) above, the algorithm of the force control according to the embodiment is represented by Formulae (29c) to (29i) corresponding to Formulae (19) representing the algorithm of the position control according to the first embodiment and additional Formulae (29a) and (29b) for constituting the force controller. Thus, in the control device and the control method for the force control according to the embodiment, the internal position controller based on the position control method according to the first embodiment is used to perform the force control. Accordingly, a high control performance can be achieved even in a case where prior information on a dynamic characteristic of a control object is inaccurate and a case where there is a time delay in response of a liquid pressure actuator.

### <Configuration of Control System>

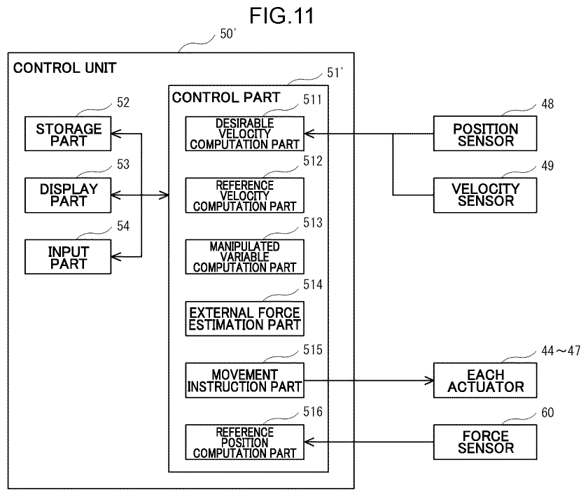

As shown in the block diagram of FIG. 11, the control part 51′ of a control unit 50′ according to the embodiment includes the reference position computation part 516 (reference position calculation part), unlike the control part 51 according to the first embodiment.

The reference position computation part 516 calculates a reference position by using the virtual object having the dynamic characteristic of the machine including the oil pressure actuator as the control object. Specifically, as shown in the algorithm above, the target applied force set as a target value of a force applied to the environment by the oil pressure actuator and a measured value of the counterforce acting on the oil pressure actuator from the environment by a force sensor 60 included in the oil pressure actuator are input to a model of the virtual object. Then, the reference position at which the control object, more specifically, the rod of the oil pressure actuator represented by the virtual object, is to be located in the next timestep is calculated. The force sensor 60 that measures the force acting on the oil pressure actuator is installed in the oil pressure actuator, or may be disposed outside the oil pressure actuator.

The desirable velocity computation part 511 according to the embodiment calculates the desirable velocity by using the reference position calculated by the reference position computation part 516. Specifically, the desirable velocity computation part 511 calculates the desirable velocity by using the reference position as the target position for the algorithm according to the first embodiment. Thus, as shown in FIG. 10, the reference position q output by the reference position computation part 516 is input to the control law according to the first embodiment serving as the internal position controller to perform the control, so that, as a whole, the force control of the control object is performed.

### <Flow of Control>

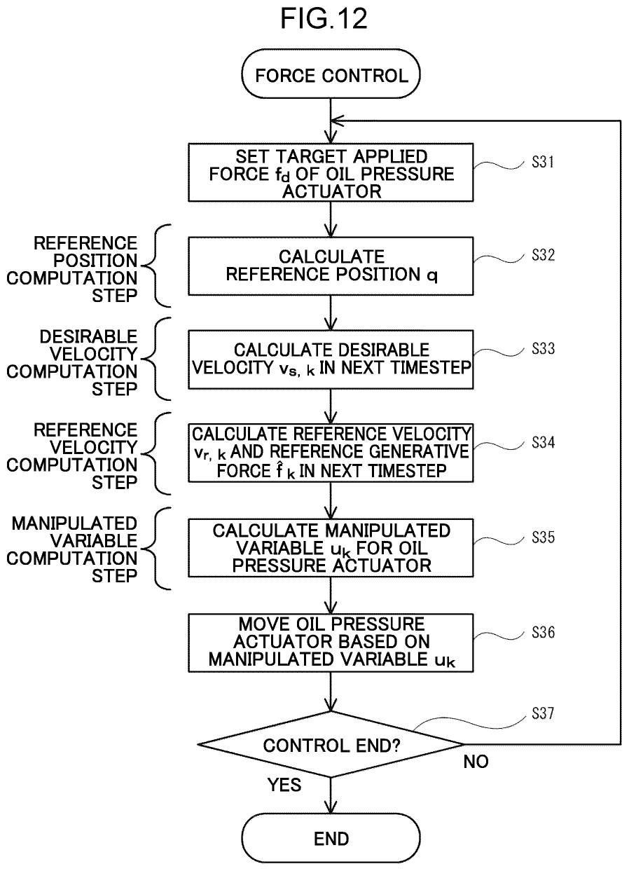

FIG. 12 is a flowchart showing a flow of the force control according to the embodiment. As shown in FIG. 12, in the force control according to the embodiment, the target applied force fa of the oil pressure actuator is set (Step S31). Then, the reference position q is computed based on the set target applied force fa and the measured value of the force fₑ acting on the oil pressure actuator (Step S32). Parameters such as the time constant H given when the control starts are predetermined as in the first embodiment.

Specifically, the reference position computation part 516 of the control part 51′ calculates the reference position at which the rod of the oil pressure actuator as the control object is to be located in the next timestep, which is the reference position computation step. An algorithm for calculating the reference position is represented by Formulae (29a) and (29b) above.

Steps S33 to S36 correspond to Steps S13 to S16 (FIG. 5) according to the first embodiment except that the reference position calculated in Step S31 is input as the target position.

In Steps S33 to S36, the internal position controller computes the manipulated variable u, so that the movement of the oil pressure actuator as the control object is controlled. The control part 51′ repeats Steps S31 to S37 (NO in Step S37) until the control process is ended by, e.g., an end instruction by the operator or expiration of a predetermined operation time. The control system ends the control process (YES in Step S37) when a predetermined end condition such as the end instruction by the operator or the expiration of the predetermined operation time is satisfied. The control part 51′ according to the embodiment achieves the force control of the control object by executing the process described above.

As described above, in the control device and the control method for performing the force control according to the embodiment, the reference velocity and the actuator force are calculated by combining the PID control law or the PD control law that causes the velocity of the control object to follow the reference velocity with the sliding mode control law, and the force control of the control object is performed by using the control law according to the first embodiment for calculating the manipulated variable for the liquid pressure actuator based on the quasistatic characteristic of the liquid pressure actuator. Therefore, a control independent of the dynamic characteristic model of the control object can be performed. Accordingly, a high control performance can be achieved even in a case where prior information on a dynamic characteristic of a control object is inaccurate and a case where there is a time delay in response of a liquid pressure actuator.

### Numerical Examples

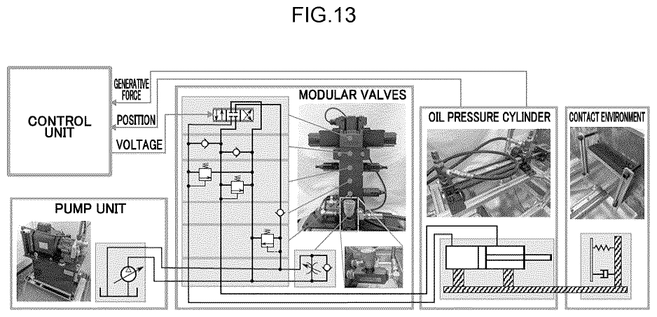

Simulations of the force control of an oil pressure actuator based on the control law according to the embodiment will be described below. In the examples, a hydraulic testing machine as shown in FIG. 13 was used to perform the admittance control according to the embodiment. The hydraulic testing machine includes a proportional flowrate control solenoid valve (uppermost modular valve), a relief valve, and a check valve. The flowrate of hydraulic oil supplied from a pump unit was constant, which was 4.17×10⁻⁴ m³/s, and the maximum force of an oil pressure cylinder was 1.56×10⁻³ N. The sampling interval was T=0.01 s.

The control unit acquires measured values of the position p of the rod and the counterforce fₑ from the environment, from a linear encoder and a load cell of the oil pressure cylinder. The control input u is converted into an input voltage for the flowrate control valve by a D/A conversion board.

As shown in FIG. 13, a rubber board fixed to a rigid wall was used as the environment in contact with the oil pressure cylinder. Further, a metal plate was placed on a surface of the rubber board so that only a load button of the load cell comes into contact with the environment. In the examples, contact experiments with rubber boards having three different hardnesses were conducted to make a comparison. The rubber boards have hardnesses of a Shore A hardness of about 50 HS (Shore A50), a Shore A hardness of about 65 HS (Shore A65), and a Shore A hardness of about 70 HS (Shore A70), with a smaller number indicating a softer rubber board.

Parameters of the control algorithm for the admittance control in the examples were set as K=2.5×10³ N/m, B=3.0×10² N·s/m, and H=0.5 s. Parameters of the virtual object were set as Bᵥ=7.5×10³ N·s/m, Mᵥ=5 kg. The parameters were determined by trial and error to keep the generative force f stable.

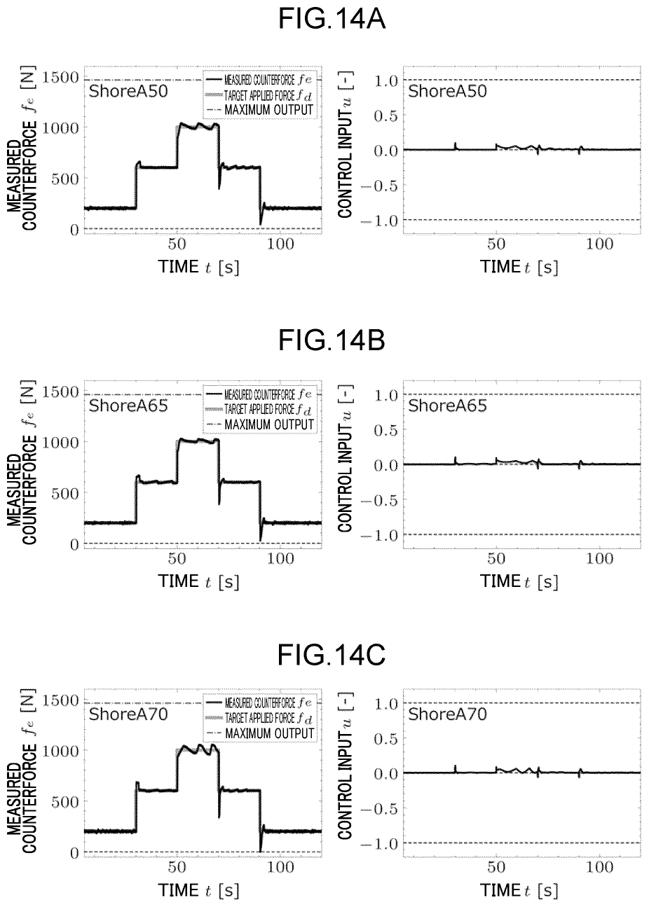

FIGS. 14A, 14B, and 14C show results of contact force control with respect to a stepwise target applied force f_{d}. As shown in FIGS. 14A, 14B, and 14C, the measured counterforce f from each of the environments with the hardnesses follows the target applied force f_{d} successfully.

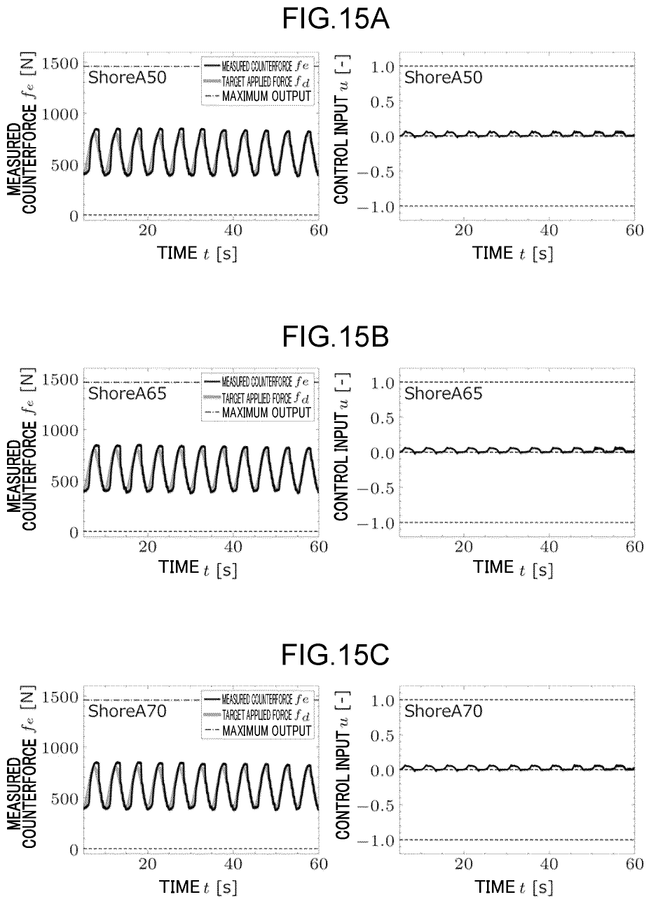

FIGS. 15A, 15B, and 15C show results of contact force control with respect to a sinusoidal target applied force f_{d}. As shown in FIGS. 15A, 15B, and 15C, the measured counterforce f from each of the environments with the hardnesses follows the target applied force f_{d} successfully.

As described above, the method for the force control according to the embodiment can cause a force applied to a rigid environment by an oil pressure actuator in contact with the environment to follow a target applied force properly.

The present invention is suitable for position control and force control of a machine actuated by a liquid pressure actuator. Particularly, the present invention is suitable for automatic position determining control and admittance control of a construction machine actuated by an oil pressure actuator.

A control device according to a first aspect of the present invention includes: a movement instruction part that controls a liquid pressure actuator for driving a machine that is a control object; a desirable velocity calculation part that calculates a desirable velocity to be produced in a next timestep for the machine based on a target position and a current position of the machine; a reference velocity calculation part that calculates a reference velocity and a reference generative force based on a quasistatic characteristic of the liquid pressure actuator, the reference velocity being a target velocity closest to the desirable velocity among target velocities from which actuator forces producible by performing PID control or PD control for the liquid pressure actuator are calculable, and the reference generative force being an actuator force to be produced by performing the PID control or PD control when the reference velocity serves as the target velocity; and a manipulated variable calculation part that calculates a manipulated variable for the liquid pressure actuator based on the quasistatic characteristic of the liquid pressure actuator, the reference generative force, and the reference velocity.

The liquid pressure actuator may include a regeneration circuit, and the desirable velocity may be calculated based on the target position and the current position of the machine, an opening degree of a flowrate control valve of the regeneration circuit, and an estimation value of a flowrate of a hydraulic liquid flowing through the regeneration circuit.

The machine may be driven by a plurality of the liquid pressure actuators, the manipulated variable calculation part may calculate the manipulated variable for each of the liquid pressure actuators, and the movement instruction part may shift a predetermined portion of the machine to the target position by controlling each of the liquid pressure actuators based on the calculated manipulated variables.

The control device may include an external force estimation part that estimates an external force applied to the machine, and the reference velocity calculation part may calculate the reference velocity and the reference generative force based on the external force estimated by the external force estimation part.

The liquid pressure actuator may be an oil pressure actuator.

The control device may include a reference position calculation part that calculates a reference position at which a virtual object representing the machine and having a target dynamic characteristic of the machine is to be located in the next timestep, by inputting to the virtual object a counterforce received by the liquid pressure actuator from an environment with which the machine is into contact and a target applied force indicating a target value of a force applied to the environment by the liquid pressure actuator, and the desirable velocity calculation part may calculate the desirable velocity using the reference position as the target position.

A control method according to a second aspect of the present invention includes: a desirable velocity calculation step of calculating a desirable velocity to be produced in a next timestep for a machine that is a control object and is driven by a liquid pressure actuator, based on a target position and a current position of the machine; a reference velocity calculation step of calculating a reference velocity and a reference generative force based on a quasistatic characteristic of the liquid pressure actuator, the reference velocity being a target velocity closest to the desirable velocity among target velocities from which actuator forces producible by performing PID control or PD control for the liquid pressure actuator are calculable, and the reference generative force being an actuator force to be produced by performing the PID control or PD control when the reference velocity serves as the target velocity; and a manipulated variable calculation step of calculating a manipulated variable for the liquid pressure actuator based on the quasistatic characteristic of the liquid pressure actuator, the reference generative force, and the reference velocity.

The control method may include a reference position calculation step of calculating a reference position at which a virtual object representing the machine and having a target dynamic characteristic of the machine is to be located in the next timestep, by inputting to the virtual object a counterforce received by the liquid pressure actuator from an environment with which the machine is into contact and a target applied force indicating a target value of a force applied to the environment by the liquid pressure actuator, and in the desirable velocity calculation step, the desirable velocity may be calculated using the reference position as the target position.

In the control device and the control method of the present invention, the reference velocity and the actuator force are calculated by combining the PID control law or the PD control law that causes the velocity of the control object to follow the reference velocity with the sliding mode control law, and the manipulated variable for the liquid pressure actuator is calculated based on the quasistatic characteristic of the liquid pressure actuator. Therefore, a control independent of the dynamic characteristic model of the control object can be performed. Accordingly, a high control performance can be achieved even in a case where prior information on a dynamic characteristic of a control object is inaccurate and a case where there is a time delay in response of a liquid pressure actuator.

1. A control device comprising:
a movement instruction part that controls a liquid pressure actuator for driving a machine that is a control object;
a desirable velocity calculation part that calculates a desirable velocity to be produced in a next timestep for the machine based on a target position and a current position of the machine;
a reference velocity calculation part that calculates a reference velocity and a reference generative force based on a quasistatic characteristic of the liquid pressure actuator, the reference velocity being a target velocity closest to the desirable velocity among target velocities from which actuator forces producible by performing PID control or PD control for the liquid pressure actuator are calculable, and the reference generative force being an actuator force to be produced by performing the PID control or PD control when the reference velocity serves as the target velocity; and
a manipulated variable calculation part that calculates a manipulated variable for the liquid pressure actuator based on the quasistatic characteristic of the liquid pressure actuator, the reference generative force, and the reference velocity.

2. The control device according to claim 1, wherein
the liquid pressure actuator includes a regeneration circuit, and
the desirable velocity is calculated based on the target position and the current position of the machine, an opening degree of a flowrate control valve of the regeneration circuit, and an estimation value of a flowrate of a hydraulic liquid flowing through the regeneration circuit.

3. The control device according to claim 1, wherein
the machine is driven by a plurality of the liquid pressure actuators,
the manipulated variable calculation part calculates the manipulated variable for each of the liquid pressure actuators, and
the movement instruction part shifts a predetermined portion of the machine to the target position by controlling each of the liquid pressure actuators based on the calculated manipulated variables.

4. The control device according to claim 1, further comprising:
an external force estimation part that estimates an external force applied to the machine, wherein
the reference velocity calculation part calculates the reference velocity and the reference generative force based on the external force estimated by the external force estimation part.

5. The control device according to claim 1, wherein the liquid pressure actuator is an oil pressure actuator.

6. The control device according to claim 1, further comprising:
a reference position calculation part that calculates a reference position at which a virtual object representing the machine and having a target dynamic characteristic of the machine is to be located in the next timestep, by inputting to the virtual object a counterforce received by the liquid pressure actuator from an environment with which the machine is into contact and a target applied force indicating a target value of a force applied to the environment by the liquid pressure actuator, wherein
the desirable velocity calculation part calculates the desirable velocity using the reference position as the target position.

7. A control method comprising:
a desirable velocity calculation step of calculating a desirable velocity to be produced in a next timestep for a machine that is a control object and is driven by a liquid pressure actuator, based on a target position and a current position of the machine;
a reference velocity calculation step of calculating a reference velocity and a reference generative force based on a quasistatic characteristic of the liquid pressure actuator, the reference velocity being a target velocity closest to the desirable velocity among target velocities from which actuator forces producible by performing PID control or PD control for the liquid pressure actuator are calculable, and the reference generative force being an actuator force to be produced by performing the PID control or PD control when the reference velocity serves as the target velocity; and
a manipulated variable calculation step of calculating a manipulated variable for the liquid pressure actuator based on the quasistatic characteristic of the liquid pressure actuator, the reference generative force, and the reference velocity.

8. The control method according to claim 7, further comprising:
a reference position calculation step of calculating a reference position at which a virtual object representing the machine and having a target dynamic characteristic of the machine is to be located in the next timestep, by inputting to the virtual object a counterforce received by the liquid pressure actuator from an environment with which the machine is into contact and a target applied force indicating a target value of a force applied to the environment by the liquid pressure actuator, wherein
in the desirable velocity calculation step, the desirable velocity is calculated using the reference position as the target position.
